(19) United States
(12) Patent Application Publication
(10) Pub. No.: US 2019/0347109 A1
(43) Pub. Date: Nov. 14, 2019

(54) SANITIZATION MODE FOR COMPUTING DEVICES

(71) Applicant: HEWLETT-PACKARD DEVELOPMENT COMPANY, L.P., Spring, TX (US)

(72) Inventor: Shubhendu Konar, Bangalore (IN)

(73) Assignee: HEWLETT-PACKARD DEVELOPMENT COMPANY, L.P., Spring, TX (US)

(21) Appl. No.: 16/405,590

(22) Filed: May 7, 2019

(30) Foreign Application Priority Data
May 10, 2018 (IN) 201841017705

(51) Int. Cl. G06F 9/4401

(52) U.S. Cl. CPC G06F 9/4418; G06F 9/4411

(57) ABSTRACT

Examples techniques for implementing a sanitization mode in a computing device are described. In an example, a basic input and output system (BIOS) of the computing device receives an indication of the initiation of a sanitization mode for the computing device. The BIOS, upon receiving the indication, disables an input device coupled to the computing system. Upon actuation of the input device, the BIOS registers the actuation and provides an output indicative of the actuation.

### BACKGROUND

User devices, such as laptops and tablets, comprise input devices to enable users to provide inputs to the user devices. Examples of input devices include keyboards, touchpads, and keypads. To provide an input to a user device, a user actuates an input device of the user device. For instance, to provide a text-based input, the user may press a combination of keys on a keyboard of the user device. Such an actuation may involve the user making contact with a surface of the input device. Accordingly, the user may sanitize the input device from time to time such that the user contacts a clean surface, for example, free of dust or pathogens.

### BRIEF DESCRIPTION OF FIGURES

The following detailed description references the drawings, wherein:

FIG. 1 illustrates a computing device, in accordance with an example implementation of the present subject matter;

FIG. 2 illustrates a computing device, in accordance with another example implementation of the present subject matter;

FIG. 3 illustrates a computing device, in accordance with another example implementation of the present subject matter;

FIG. 4 illustrates a method for implementing a sanitization mode in a computing device, according to an example of the present subject matter:

FIG. 5 illustrates a method for implementing a sanitization mode, in a computing device according to another example of the present subject matter; and

FIG. 6 illustrates a computing environment for implementing a sanitization mode in a computing device, according to an example implementation of the present subject matter.

### DETAILED DESCRIPTION

Computing devices, such as desktops, laptops, and tablets, include input devices, such as keyboards, keypads, clickpads, and touchpads that may be actuated based on a contact by a user. The input devices may also include pointing device, joysticks, and other external devices that are touched for being actuated. Such input devices are generally sanitized for reasons, such as maintaining hygiene. For instance, in a healthcare facility, a healthcare service provider may sanitize an input device after visit of each patient to avoid a possibility of transfer of pathogens, from one patient to another, based on the contact of the healthcare service provider with the input device in the course of dealing with each patient.

For sanitizing an input device of a computing device, the computing device may be put in a sanitization mode. Generally, the sanitization mode may be initiated by launching, on an operating system (OS) of the computing device, an application that may discard input to prevent the taking of an action in response to an input received from the input device during the sanitization mode. Thus, in the sanitization mode, the application and the OS may not respond to actuation of the input device resulting from a cleaning action on the input device by a user. However, in such cases there exists a likelihood of inadvertent actuation of an input, for instance, a combination of keys of a keyboard, that may be read by the OS or other applications running on the OS (e.g., a key or combination of keys that changes focus to the OS or the other applications). Such an input may result in an action that may be inconvenient for the user to undo.

Also, since the OS of the computing device may take no cognizance of actuation of input devices while in the sanitization mode, a feedback relating to the cleaning action performed by the user may generally not be provided by the computing device. For instance, a user using a sanitization wipe to clean keys of a keyboard may not be provided any indication with respect to the keys that may have been wiped and the ones that are yet to be wiped.

According to examples of the present subject matter, techniques for implementing a sanitization mode in computing devices are described. The example techniques for implementing a sanitization mode, on one hand, provide for disabling input devices of a computing device such that no inadvertent inputs are read by an OS of the computing device, and on the other hand, provide for an output indicative of actuation of the input devices by a user in the sanitization mode. The output indicative of the actuation of the input devices in the sanitization mode may serve to provide a real-time feedback regarding sanitization of the input devices the user.

In an example implementation, a basic input and output system (BIOS) of a computing device may be provided an indication of initiation of a sanitation mode for the computing device. Upon receiving the indication, the BIOS may disable an input device coupled to the computing device, such that an OS of the computing device is unable to communicate with the input device. Disabling the communication between the input device and the OS prevents the OS from receiving and processing any inadvertent inputs from the input devices. Further, in an example, the BIOS registers actuation of the input device in sanitation mode and accordingly provides an output indicative of the actuation of the input device to the user.

In an example, the input device comprises a keyboard including a plurality of a light emitting diodes (LEDs), each associated with a corresponding key on the keyboard. Actuation of a key in the sanitation mode, may be registered. Based on the registration of actuation of the key, the LED corresponding to the key may be operated, for example, by changing an operation state or colour of the LED. Accordingly, the user may be notified regarding keys that were not actuated in the sanitation mode, for instance, due to lack of a cleaning action being performed on them.

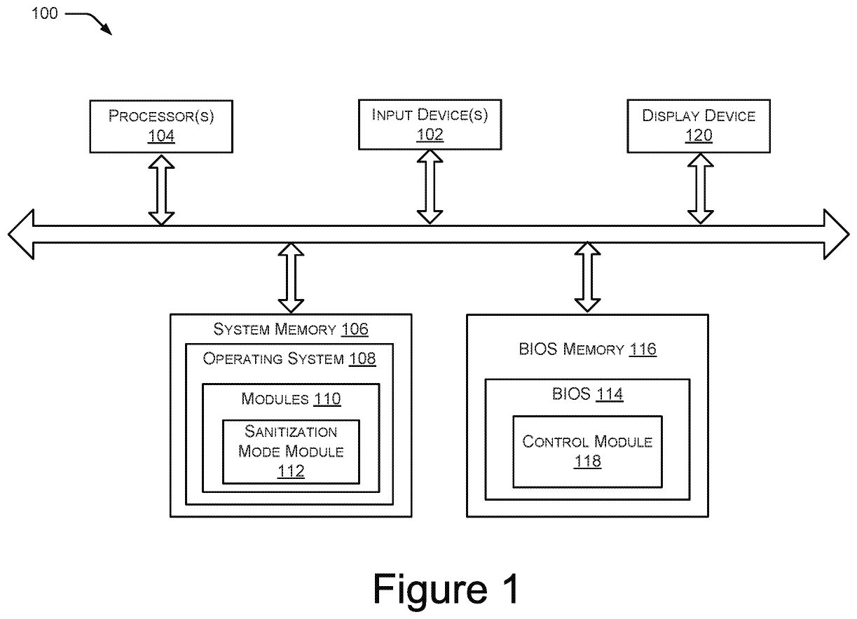

The above techniques are further described with reference to FIG. 1 to FIG. 6. It should be noted that the description and the figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows a computing device 100 according to an example implementation of the present subject matter. The computing device 100 of the present subject matter comprises input device(s) 102, in an example. Examples of the computing device 100 include, but are not limited to, an electronic device, such as a desktop computer, a laptop, a smartphone, a personal digital assistant (PDAs), and a tablet that may include or may be interfaced with the input device(s) 102. Examples of the input devices 102 include internal input devices, such as such as keyboards, keypads, clickpads, and touchpads; external input devices, such as pointing devices, and external keyboards, for example, which may be interfaced with the computing device 100 via an input/output (I/O) port, such a USB port; as well as any other devices that may operate based on a contact by a user, for instance, a power switch of the computing device 100.

The computing device 100, among other things, includes processor(s) 104. The processor(s) 104 may be implemented as microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in a memory, such as a system memory 106 where an operating system (OS) 108 of the computing device 100 may reside.

The system memory 106 may include any non-transitory computer-readable medium including, for example, non-volatile memory (e.g., EPROM, flash memory, etc.) and/or volatile memory (e.g., RAM). The OS 108 is a set of instructions that manages the hardware and software of the computing device 100 to enable the computing device 100 to provide various functionalities to users. In an example, the OS 108 comprises module(s) 110 to provide the various functionalities. The modules 110 include routines, programs, objects, components, data structures, and the like, which perform tasks or implement abstract data types.

In an example, the modules 110 comprise a sanitization mode module 112. The sanitization mode module 112 may provide functionalities relating to implementation of a sanitization mode for the computing device 100, such as receiving a user input relating to initiation of the sanitization mode, recording duration of the sanitization mode and so on. Details of the sanitization mode module 112 have been elaborated later.

The computing device 100 also includes a basic input and output system (BIOS) 114, which may reside in a BIOS memory 116. The BIOS 114 performs hardware initialization to prepare the computing device 100 for use when the computing device 100 is booted up. The BIOS 114 also provides an interface between I/O devices (not shown), such as the input devices 102 of the computing device 100, and the OS 108 during the boot up process. However, once the OS 108 is initialized, the OS 108 can communicate with the I/O devices including the input devices 102 directly. To interface the input devices 102 to the OS 108, an accessibility of each of the input devices 102 may be defined in the BIOS 114. Accordingly, if an input device 102 is defined to be disabled in the BIOS 114, the input devices 102 may not communicate with the OS 108.

In accordance with an example implementation of the present subject matter, a control module 118 of the BIOS 114 receives an indication of initiation of the sanitation mode by the OS 108 of the computing device 100. For example, the sanitization mode module 112 may provide the indication to the BIOS 114 based on a user input that the sanitization mode module 112 may receive from a user. Upon receiving the indication of the initiation of the sanitization mode, the control module 118 disables the input devices 102 such that the OS 108 is not able to communicate with the input devices 102.

Once the input devices 102 are disabled, the computing device 100 enters the sanitization mode. The input devices 102 may be sanitized in the sanitization mode. During the sanitization mode, the control module 118 registers the actuation of the input devices 102 of the computing device 100. Such actuation of the input devices 102 in the sanitization mode may be a result of a user cleaning the input devices 102, for example, by wiping the input devices 102 with a sanitization wipe. Based on registered actuation of the input devices 102 in the sanitization mode, an output indicative of the actuation of the input devices 102 and in turn indicative of the input devices 102 being cleaned, is provided to the user.

In an example, the output may be provided as a notification which may be displayed on a display device 120 of the computing device 100. For instance, the notification may mention ‘yes’ or ‘no’ against each of the input devices 102 depending on whether the actuation of a corresponding input device 102 was registered or not.

In another example, the output may be provided using a diagrammatic representation of the input devices 102. The control module 118 may display the diagrammatic representation of the input devices 102 on the display device 120 and may indicate the actuation of the input devices 102, for example, by changing a depiction of the respective input devices 102 on the diagrammatic representation once they are actuated. For instance, when any of the input devices 102 is actuated in the sanitization mode, a colour of its diagrammatic representation on the display device 120 may be changed.

With the BIOS 114 registering the actuation of the input devices 102 in the sanitization mode, the output indicative of the actuation enables a user to be informed of the input devices 102 that are sanitized and the ones are yet to be sanitized. The output provides a feedback to the user who may not have cleaned the input devices 102 adequately or who may have missed cleaning each of the input devices 102. For example, if the user cleans a keyboard (not shown in FIG. 1) of the computing device 100 and inadvertently misses cleaning a mouse (not shown in FIG. 1) of the computing device 100, the output may notify the user on a real-time basis.

Also, with the BIOS 114 registering the actuation of the input devices 102, the BIOS 114 may transfer commands relating to the sanitation mode to the OS 108. For example, the BIOS 114 may register a command, such as actuation of a combination of keys of the keyboard as a command to terminate the sanitization mode and may transfer the same to the OS 108. Thus, the BIOS 114 may transfer predefined commands alone and may otherwise disable communication between the input devices 102 and the OS 108, such that inadvertent inputs are prevented from being transferred to the OS 108 in the sanitization mode.

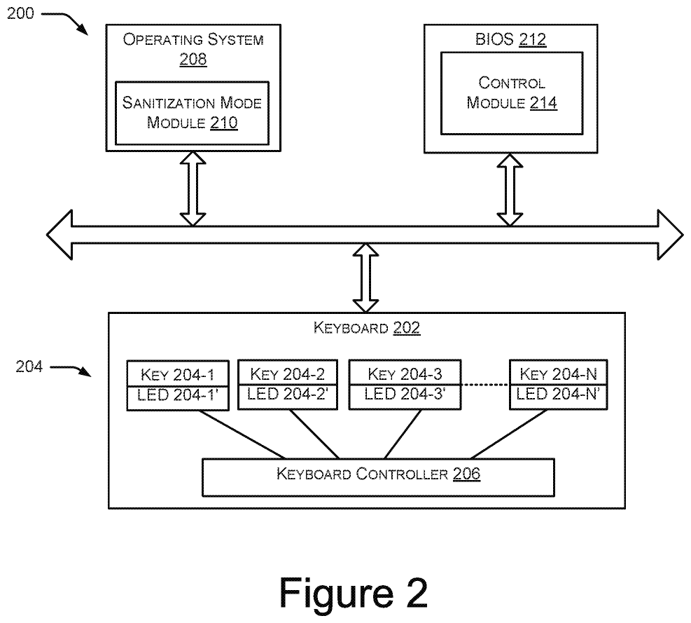

FIG. 2 illustrates a computing device 200, in accordance with another example implementation of the present subject matter. The computing device 200 comprises a keyboard 202 having keys 204-1, 204-2, 204-3, and 203-N, hereinafter referred to as keys 204. The keys 204 are coupled to a keyboard controller 206 of the keyboard 202.

In an implementation, the keys 204 are associated with LEDs 204-1′, 204-2′, 204-3′, and 204-N′, respectively, hereinafter referred to as LEDs 204′. For example, the key 204-1 is coupled to an LED 204-1′, the key 204-2 is coupled to an LED 204-2′, and so on. Each of the keys 204 is associated with a symbol, digit, character, etc. A key may be pressed for providing an input to the computing device 200 corresponding to the symbol, digit, or character, associated with the key. The keyboard controller 206 detects the depression of the keys 204 and may operate the corresponding LEDs 204′ to illuminate the respective keys 204 when they are pressed.

In an example, the keys 204 of the keyboard 202 may be made up of a transparent material and may comprise an opaque portion shaped as the corresponding character, symbol, digit, etc. The LEDs 204′ may be embedded below the corresponding keys 204 such that the transparent material transmits the light emitted by the LEDs 204′ to illuminate the respective keys 204 when the LEDs 204′ are actuated.

In a normal mode of operation, i.e., when the computing device 200 is not in the sanitization mode, the keyboard controller 206 senses the actuation of the keys 204 and provides a corresponding input to an OS 208 of the computing device 200. The OS 208 may be similar to the above-described OS 108 of the computing device 100 in an example. The OS 208 may process the received input or may provide the input to applications running on the OS 208.

In an example, a user may actuate a key, such as a key 204-1, or a combination of keys of the keyboard 202 to initiate a sanitization mode for the computing device 200. In an example, the keyboard 202 may comprise a sanitization mode key that may be actuated for triggering the sanitization mode. The user input to initiate the sanitization mode, provided via the keyboard 202, is registered by the keyboard controller 206 and is communicated to the OS 208. The OS 208 of the computing device 200 hosts a sanitization mode module 210 that recognizes the user input to initiate the sanitization mode and accordingly takes further action.

In an example, based on the user input to start the sanitization mode for the computing device 200, the sanitization mode module 210 may provide an indication of initiation of the sanitization mode to a BIOS 212 of the computing device 200. The BIOS 212 may be similar to the BIOS 114 of the computing device 100 in an example. The indication is received by a control module 214 of the BIOS 212. The control module 214 of the BIOS 212, upon receiving the indication from the sanitization mode module 210, decouples the keyboard 202 from the OS 208. In an example implementation, a user input to initiate the sanitization mode may be registered by the keyboard controller 206 and may be directly transferred to the control module 214 of the BIOS 212. The control module 214 of the BIOS 212, upon receiving the indication to initiate the sanitization mode, may disable the OS 208 from accessing the keyboard 202.

Once the keyboard 202 is decoupled from the OS 208, the computing device 200 enters the sanitization mode. Thereupon, the user may sanitize the keyboard 202, for example, by using a sanitizing wipe to wipe the keyboard 202. During wiping of the keyboard 202, the keys 204 that are wiped are depressed. As the communication between the keyboard 202 and the OS 208 is suspended in the sanitization mode, the actuation of the keys 204 due to the keys 204 being depressed in the course of their cleaning, is not read by the OS 208 or the applications running on the OS 208.

Also, once the sanitization mode is turned ON, the control module 214 of the BIOS 212 provides a command to the keyboard controller 206. The command may notify the keyboard controller 206 that the computing device 200 is in the sanitization mode, such that the keyboard controller 206 may operate the LEDs 204′ to provide an output representative of an outcome of the cleaning action performed by the user during the sanitization mode. Thus, the keyboard controller 206 may control the operation the LEDs 204′ corresponding to each of keys 204, based on the actuation of the keys 204 in the sanitization mode. Based on the command, the keyboard controller 206 may register the actuation of the keys 204 and control the operation the LEDs 204′ associated with the keys 204 to indicate the actuation of the corresponding keys 204.

In an example implementation, on receiving the command at the initiation of the sanitization mode, the keyboard controller 206 may switch ON the LEDs 204′ associated with the keys 204. The keyboard controller 206 may then switch OFF the LEDs 204′ as the actuation of the corresponding keys 204 is registered. In another example, the LEDs 204′ may be in switched OFF state when the sanitization mode is initiated and the LEDs 204′ may be turned ON by the keyboard controller 206 as the corresponding keys 204 are actuated. In yet another example, a colour of a light emitted by the LED 204′ or an intensity of a light emitted by the LED 204′ may be changed to indicate the actuation of the corresponding keys 204.

Based on the operation of the LEDs 204′ the user may be made aware of the keys 204 that have been sanitized and the keys 204 that are left unsanitized. In an example, the LED 204-1′ associated with the key 204-1 would not be operated if the key 204-1 is not actuated by the user after the initiation of the sanitization mode, indicating that the key 204-1 has not been wiped and thus, not sanitized. However, if during wiping of the keyboard 202, the key 204-1 is wiped and is consequently actuated, the LED 204-1′ associated with the key 204-1 is operated to indicate that the key 204-1 has been sanitized.

Indication of sanitization of keyboard 202 through the LEDs 204′ provides real-time feedback to the user regarding the sanitization of the keys 204. The user can infer the sanitization of a key 204 from the operational state of the LED 204′ corresponding to that key 204. Also, in cases where the user is not logged in into the OS 208, for example, when the user's account is locked, the use of the LED 204′ allows the real-time feedback to be provided without the user having to log in.

In example implementations where the LEDs 204′ associated with the keys 204 provide the feedback regarding the sanitization of the keyboard 202, a display device (not shown in FIG. 2) of the computing device 200 may be turned OFF in the sanitization mode to conserve power.

After the sanitization of the keyboard 202 is carried out, the sanitization mode may be terminated based a user input. For example, the user may press a key, such as the key 204-1 or a combination of keys 204 of the keyboard 202 as a command for termination of the sanitization mode. In an example, the key 204-1 may be the sanitization mode key. In an example, sanitization mode key may be used to provide a user input for termination of the sanitization mode in addition to the user input for initiation of sanitization mode. The control module 214 of the BIOS 212, upon receiving the command for termination of sanitization mode, may couple the keyboard 202 to the OS 208 and re-enable the communication between the keyboard 202 and the OS 208.

In another example, the termination of the sanitization mode may be independent of a user input. In an implementation, the sanitization mode module 210 may determine the time of receipt of the user input that initiated the sanitization mode. After a predetermined time period from the receipt of the user input is elapsed, the sanitization mode module 210 may request the BIOS 212 to terminate the sanitization mode. In another example, the control module 214 of the BIOS 212 may determine the time of receipt the indication of the initiation of the sanitization mode and may terminate the sanitization mode after expiry of a predetermined time period from the receipt the indication by restoring the communication between the keyboard 202 and the OS 208.

In an example, the predetermined time period may be defined by a user or a manufacturer of the computing device 200 by selecting a time duration for which the sanitization mode should be ON once initiated. For instance, the predetermined time period may be 2 minutes. In another example, for instance, where the computing device 200 may be of a large dimension or may incorporate several input devices 102, the predetermined time period may be higher than 2 minutes, for example, the predetermined time period may be 4 minutes. Similarly, if the computing device 200 is compact in size, the predetermined time period may be reduced accordingly.

In an example, the sanitization mode module 210 may display a timer, on the display device, which may indicate the remaining time before the sanitization mode is terminated. Further, the sanitization mode module 210 may also display a notification on the display device indicating the termination of the sanitization mode once the sanitization mode is terminated based on the user input of the elapsed of the predetermined time.

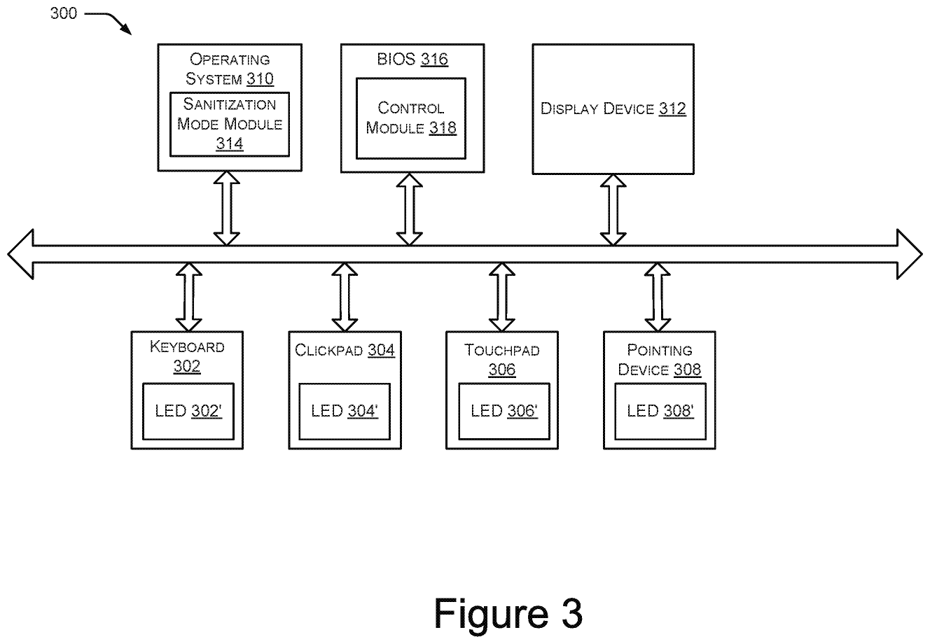

FIG. 3 illustrates a computing device 300, in accordance with another example implementation of the present subject matter. In an example, the computing device 300 comprises input devices, such as a keyboard 302, clickpad 304, touchpad 306, and pointing device 308 to provide inputs to the OS 310 of the computing device 300. In an example implementation, the keyboard 302 may have a plurality of LEDs 302′, similar to the LEDs 204′. Likewise, LEDs 304′, 306′ and 308′ may be associated with the clickpad 304, touchpad 306, and pointing device 308, respectively, such that the LEDs 304′, 306′ and 308′ may be operated based on the actuation of the respective input devices.

In addition to the above explained examples where a user may initiate a sanitization mode by providing a user input through the keyboard 302, in other examples, the user may use the clickpad 304, touchpad 306, or pointing device 308 to provide the user input to initiate the sanitization mode. The user may use the clickpad 304, touchpad 306, or pointing device 308 to provide the user input through a graphical interface displayed on a display device 312 of the computing device 300. A sanitization mode module 314 in the OS 310 of the computing device 300 may detect the user input provided through the graphical interface. The sanitization mode module 314, alike the sanitization mode module 210 explained above, may request a BIOS 316 of the computing device 300 to initiate the sanitation mode. A control module 318 of the BIOS 316 initiates the sanitization mode by suspending the transfer of inputs from the keyboard 302, the clickpad 304, the touchpad 306, the pointing device 308 and to the OS 310.

During the sanitization mode, the control module 318 registers the actuation of the keyboard 302, clickpad 304, touchpad 306, and pointing device 308 and provides an indication of their registered actuation. In an example, control module 318 controls the LEDs 302′, 304′, 306′ and 308′ associated with the respective input devices to provide the indication. The indication may comprise a change in an operation state, a change in a colour of a light emitted or a change in an intensity of a light emitted by the LEDs 302′, 304′, 306′ and 308′.

In another example, the control module 318 may sense a portion of the touchpad 306 or clickpad 304 or both being touched, as a result of the respective input device being sanitized. In an example, the control module 318 may display a diagrammatic representation of the keyboard 302, clickpad 304, touchpad 306, and/or pointing device 308 to provide the indication of their actuation through their respective diagrammatic representation. For example, upon actuation of a key of the keyboard 302 in the sanitization mode, the control module 318 may highlight the corresponding key in the diagrammatic representation of the keyboard 302 to indicate the actuation of that key.

In an example, the control module 318 may change, in the diagrammatic representation, the depiction of the portion clickpad 304 or the touchpad 306 that is touched during sanitization. For example, the control module 318 may display, on the display device 312, a matrix corresponding to an area of the clickpad 304 or the touchpad 306. Upon user touching the clickpad 304 or the touchpad 306 during the sanitization mode, the control module 318 may determine the portion being touched and may highlight the corresponding portion of the clickpad 304 or the touchpad 306 on the matrix. For example, at the initiation of the sanitization mode, the matrix representing the clickpad 304 or the touchpad 306 may be shown in red colour and a portion of the matrix may change to green colour based on the user touching the corresponding portion on the clickpad 304 or the touchpad 306. In an example, the total area matrix may turn green indicating that the total area of the clickpad 304 or the touchpad 306 has been touched and thus, sanitized. Further, in an example, the control module 318 may diagrammatically represent a left key and right key (not shown in figures) of the clickpad 304 and may highlight the left key or the right key or both based on which key is actuated.

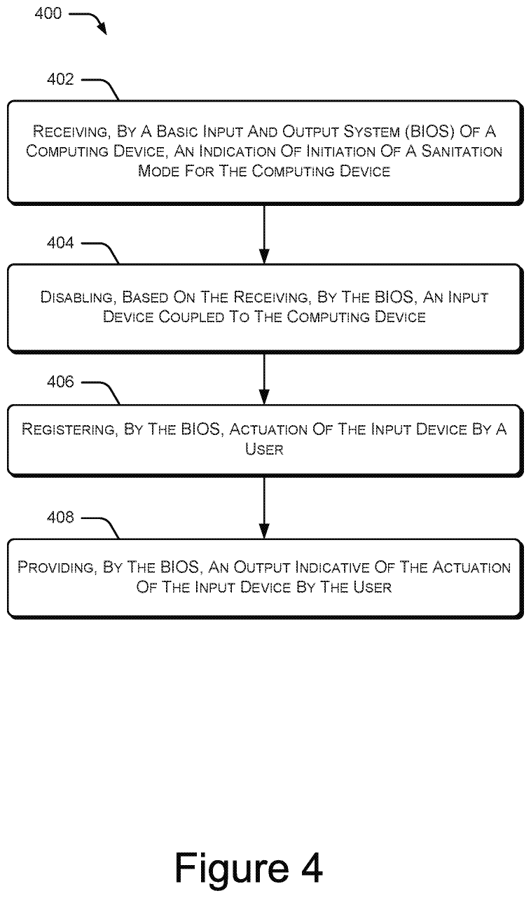

FIG. 4 illustrates a method 400 for implementation a sanitization mode in a computing device in accordance with an example of the present subject matter. Although the method 400 and may be implemented in a variety of computing devices, for the ease of explanation, the present description of the example method 400 to implement sanitization mode is provided in reference to the above-described computing device 100.

The order in which the method 400 is described is not intended to be construed as a limitation, and any number of the described method blocks may be combined in any order to implement the method 400, or an alternative method.

It may be understood that blocks of the method 400 may be performed by the computing device 100. The blocks of the method 400 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 402, a BIOS, such as BIOS 114 of the computing device 100, receives an indication to initiate a sanitization mode for the computing device 100. In an example, the indication may be based on a user input that the computing device 100 may receive from a user.

At block 404, based on the indication received at 402, the BIOS 114 disables an input device coupled to the computing device 100. The input device may be any of the input devices 102, such as a keyboard, clickpad, pointing device, for example, a mouse and so on. Disabling the input device suspends direct communication between the OS 108 of the computing device 100 and the input device. Accordingly, in the sanitization mode, the BIOS 114 alone may register inputs of the input device.

At block 406, the BIOS 114 registers the actuation of the input devices and subsequently at block 408 provides an output indicative of the actuation of the input devices. In an example, the output may be provided based on operation of LEDs associated with the input device. In another example, the output may be provided using a notification or diagrammatic representation of the input device that may be presented on a display device, such as the display device 120 of the computing device 100.

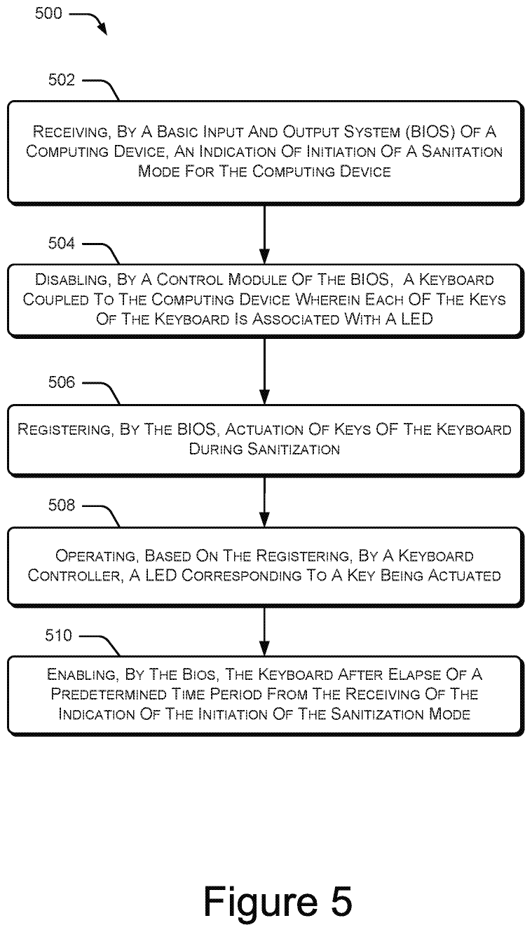

FIG. 5 illustrates a method 500 for implementation a sanitization mode in a computing device in accordance with an example of the present subject matter. Although the method 500 and may be implemented in a variety of computing devices, for the ease of explanation, the present description of the example method 500 to implement the sanitization mode is provided in reference to the above-described computing system 100.

The order in which the method 500 is described is not intended to be construed as a limitation, and any number of the described method blocks may be combined in any order to implement the method 500, or an alternative method.

It may be understood that blocks of the method 500 may be performed by the computing device 100. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 502, a BIOS, such as BIOS 114 of the computing device 100, receives an indication to initiate a sanitization mode for the computing device 100. In an example, the BIOS 114 may receive the indication from a OS of the computing device based on a user input which is being provided to the computing device 100.

At block 504, the BIOS 114 disables a keyboard coupled to the computing device. In an example implementation, the control module 118 of the BIOS 114 may disable the keyboard. In an example, the keyboard comprises keys such that each of the keys of the keyboard is associated with an LED, alike the keyboard 202 of the computing device 200.

At block 506, the BIOS 114 registers actuation of the keys of the keyboard. In an example, the keys may be actuated due to the user wiping the keyboard for sanitizing the same. Based on the registered actuation, at block 508, the LEDs associated with the keys are operated, for example, by a keyboard controller of the computing device 100, to indicate the actuation of the keys. The indication of the actuation of the keys in effect signifies, to a user, the keys that have been sanitized and the keys that are yet to be sanitized. This provides for the user to assess the cleaning action performed by him and accordingly take corrective measures.

At block 510, the BIOS 114 enables the keyboard after expiry of a predetermined time from receiving of indication of the initiation of the sanitization mode thereby terminating the sanitization mode. Thus, the communication between the OS and the keyboard may be restored and OS may start registering inputs from the keyboard upon termination of the sanitization mode.

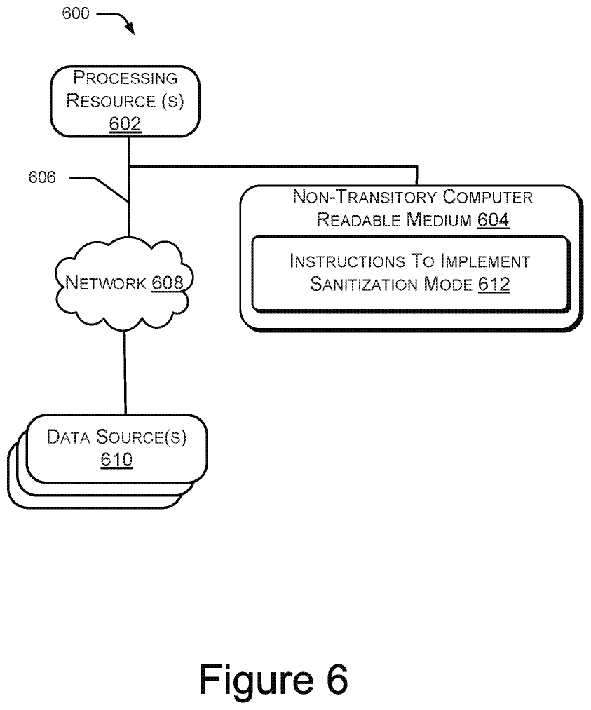

FIG. 6 illustrates a computing environment implementing a non-transitory computer-readable medium for implementing sanitization mode in a computing device, according to an example. In an example, the computing environment 600 may comprise a computing device, such computing device 100. The computing environment 600 includes a processing resource 602 communicatively coupled to the non-transitory computer-readable medium 604 through a communication link 606. In an example, the processing resource 602 may be a processor of the computing device 100 that fetches and executes computer-readable instructions from the non-transitory computer-readable medium 604.

The non-transitory computer-readable medium 604 can be, for example, an internal memory device or an external memory device. In an example, the communication link 606 may be a direct communication link, such as any memory read/write interface. In another example, the communication link 606 may be an indirect communication link, such as a network interface. In such a case, the processing resource 602 can access the non-transitory computer-readable medium 604 through a network 608. The network 608 may be a single network or a combination of multiple networks and may use a variety of different communication protocols.

The processing resource 602 and the non-transitory computer-readable medium 604 may also be communicatively coupled to data sources 610. The data source(s) 610 may be used to store data, such as time period since the initiation of the sanitization mode. In an example, the non-transitory computer-readable medium 604 comprises executable instructions 612 for implementing a sanitization mode in a computing device. For example, the non-transitory computer-readable medium 604 may comprise instructions executable to implement the previously described sanitization mode module 112 and control module 118.

In an example, the instructions 612 may be executable by the processing resource 602 to cause a BIOS of the computing device to receive a request to initiate a sanitization mode for the computing device. In an example, based on a user input received at an OS of the computing device, the instructions 612 may be executable by the processing resource 602 to cause the BIOS to be provided the request to initiate the sanitization mode. For instance, the instructions 612 may be executable by the processing resource 602 to cause the request to initiate the sanitization mode to be generated by a sanitization mode module of the OS upon receiving the user input.

The instructions 612 may further cause the BIOS to disable communication between the OS of the computing device and an input device of the computing device to initiate the sanitization mode. The input device, for example, a keyboard, touchpad, clickpad, or pointing device is disabled to avoid reading of irrelevant input by the OS. Further, the disabling of the input device also ensures that the sanitization mode is not terminated unintentionally.

In the sanitization mode, a user may wipe the input device which may result in actuation of the input device. For example, wiping of the input device, such as a keyboard may result in actuation of the keys of the keyboard while wiping of a clickpad may result in the actuation of the clickpad. The instructions 612 may be executable by the processing resource 602 to cause the BIOS to register the actuation of the input device in the sanitization mode. Further, the instructions 612 may cause the BIOS to indicate the actuation of the input device. The indication of the actuation may serve as a feedback to a user sanitizing the input device.

In an example, the indication may be provided through LEDs associated with the input device. For example, a LED may be associated with the input device, such as a mouse of the computing device, which may be switched ON when the mouse is actuated in the sanitization mode. Further, in an example, the indication through the LEDs may be provided by changing the operational state of the LEDs, such as a change in a colour of a light emitted or a change in an intensity of a light emitted by a LED associated with the input device.

In an example, the input device may be a keyboard including a plurality of LEDs each associated with a corresponding key on the keyboard. The instructions 612 may further cause the BIOS to register an actuation of a key of the keyboard in the sanitization mode and operate an LED associated with the key based on the registered actuation of the key.

In an example, in implementations where the indication of actuation of input devices in the sanitization mode is provided by the LEDs, the instructions 612 may cause a display device of the computing device to be switched OFF. Switching OFF of the display device in the sanitization mode may provide for power conservation.

Further, the instructions 612 may cause the BIOS to receive a request to terminate the sanitization mode. The BIOS may thereafter terminate the sanitization mode by enabling the communication between the OS of the computing device and the input devices. In an example, the request for termination may be based on a user input, such a user actuating a key of the keyboard of the computing device. Further, in another example, the BIOS may terminate the sanitization mode based elapsing of a predetermined time since the receipt of the request for initiating the sanitization mode.

Thus, the methods and devices of the present subject matter provide techniques to implement a sanitization mode in a computing device. Although examples of implementation of the sanitization mode are described have been described in a language specific to structural features and/or methods, it is to be understood that the appended claims are not necessarily limited to the specific features or methods described. Rather, the specific features and methods are disclosed as example for implementing the sanitization mode.

1. A method comprising:
receiving, by a basic input and output system (BIOS) of a computing device, an indication of initiation of a sanitation mode for the computing device;
disabling, based on the receiving, by the BIOS, an input device coupled to the computing device;
registering, by the BIOS, actuation of the input device by a user; and
providing, by the BIOS, an output indicative of the actuation of the input device by the user.

2. The method as claimed in claim 1 further comprising enabling, by the BIOS, the input device after expiry of a predetermined time period from the receiving of the indication of the initiation of the sanitization mode.

3. The method as claimed in claim 1, wherein the input device comprises a keyboard, such that a key of the keyboard has a light emitting diode (LED) operable upon actuation of the key, and wherein
registering the actuation comprises sensing a depression of the keys; and
providing the output comprises at least one of changing an operation state of the LED, changing a color of a light emitted by the LED and changing an intensity of a light emitted by the LED when the key is sensed to be depressed.

4. The method as claimed in claim 1, wherein providing the output further comprises displaying a diagrammatic representation of the input device on a display device of the computing device.

5. The method as claimed in claim 4, wherein the input device comprises a touchpad or a clickpad, and wherein
registering the actuation comprises sensing a portion of the touchpad or the clickpad being touched by a user; and
providing the output comprises changing a depiction of the portion of the touchpad or the clickpad in the diagrammatic representation when the portion of the touchpad or clickpad is touched.

6. The method as claimed in claim 1, wherein providing the output further comprises displaying a notification of actuation of the input device on a display of the computing device.

7. A computing device comprising:
a keyboard comprising:
keys with each of the keys being associated with a light emitting diode (LED); and
a keyboard controller to control an operation of the LED corresponding to each of the keys;
an operating system (OS) to receive input from the keyboard, the OS comprising:
a sanitization mode module to receive a user input to initiate a sanitization mode: and
a basic input and output system (BIOS), to couple to the keyboard, the BIOS comprising:
a control module to:
decouple the keyboard from the OS upon the sanitization mode being initiated; and
provide a command to the keyboard controller to operate the LED corresponding to each of keys, based on actuation of the keys in the sanitization mode.

8. The computing device as claimed in claim 7, wherein the control module is to receive, from the keyboard, a command to terminate the sanitization mode, and wherein the sanitization mode module is to provide a notification of termination of the sanitization mode.

9. The computing device as claimed in claim 7, further comprising a pointing device to provide inputs to the OS, wherein the control module is to suspend transfer of the inputs from the pointing device to the OS in the sanitization mode.

10. The computing device as claimed in claim 7, further comprising a touchpad or clickpad wherein the control module is to suspend transfer of inputs from the touchpad or clickpad to the OS in the sanitization mode.

11. The computing device as claimed in claim 7, further comprising a display device, wherein the control module is to disable the display device in the sanitization mode.

12. A non-transitory computer-readable medium comprising instructions executable by a processing resource to:
receive, by a BIOS of a computing device, a request to initiate a sanitization mode;
disable, by the BIOS, communication between an operation system (OS) of the computing device and an input device of the computing device to initiate the sanitization mode;
register, by the BIOS, an actuation of the input device by a user in the sanitization mode;
providing, by the BIOS, an indication of the registered actuation in the sanitization mode;
receive, by the BIOS, a request to terminate the sanitization mode; and
enable the communication between the OS and the input device to terminate the sanitization mode.

13. The non-transitory computer-readable medium as claimed in claim 12, wherein the input device is a keyboard including a plurality of light emitting diodes (LEDs) each associated with a corresponding key on the keyboard and the non-transitory computer-readable medium further comprising instructions executable by the processing resource to:
register an actuation of a key of the keyboard; and
operate an LED associated with the key based on the registered actuation of the key.

14. The non-transitory computer-readable medium as claimed in claim 12, wherein the indication comprises a change in an operation state, a change in a color of a light emitted or a change in an intensity of a light emitted by a LED associated with the input device.

15. The non-transitory computer-readable medium as claimed in claim 12, further comprising instructions executable by the processing resource to:
cause a display of the computing device to enter a low power or off state in response to initiation of the sanitization mode.
